(19) United States
(12) Patent Application Publication
(10) Pub. No.: US 2025/0366494 A1
(43) Pub. Date: Dec. 4, 2025

(54) Food Product and Method of Manufacture

(71) Applicant: Primal Pet Foods Inc., Fairfield, CA (US)

(72) Inventors: James Templeman, Guelph (CA); Kaustubh Kale, Abilene, TX (US); Lindsay Meyers, Fairfield, CA (US); Jason D. Trevino, Abilene, TX (US); Michael Kelly, Burleson, TX (US); Michael Holly, Fairfield, CA (US)

(21) Appl. No.: 19/222,178

(22) Filed: May 29, 2025

Related U.S. Application Data
(60) Provisional application No. 63/653,074, filed on May 29, 2024.

(51) Int. Cl. A23K 10/20; A23K 40/20; A23K 50/42

(52) U.S. Cl. CPC A23K 10/20; A23K 40/20; A23K 50/42

(57) ABSTRACT

A process for producing a food product is disclosed. The process comprises mixing a ground meat component with additional food components to form a first mixture. Adding CO₂ to the first mixture and mixing to form a second mixture. The mixing to produce the first mixture and the mixing to produce the second mixture occur at a temperature below zero. A food product produced by the described process is also disclosed. The food product comprises A food product comprising a ground meat component in which the density of the product is reduced by mixing components including the ground meat component while adding to CO₂ to the mixture and mixing the CO₂ in at a temperature below freezing.

### FIELD OF THE DISCLOSURE

This disclosure relates to foods, and particularly foods incorporating freeze-dried meat protein. The disclosure further relates to a food incorporating such a meat protein wherein the product has a reduced physical density characteristic resulting from the exposure of at least a portion of the meat protein to carbon dioxide gas in a mixing step.

### BACKGROUND OF THE DISCLOSURE

A wide variety of existing pet food products are described in many published technical articles, patent applications, and issued patents. Innovation in this area has increased as consumers seek pet food products that are tailored to address nutritional and health needs impacting their pets and as manufacturers seek to fill such consumer needs. Some examples include:

U.S. published patent application US 2015/0374014 A1 describes an “aerated pet treat”. This application references bulk density, bubbles per cubic millimeter and calorie density. The method of making includes whipping using a blender.

U.S. published patent application US 2009/0110778A1 describes a pet food product which, in some implementations, can be lower density and into which gas can be injected for stability and/or for the inclusion of aroma components. This publication refers to extrusion as a method of controlling product density and to creating a hollow core for the product. U.S. Pat. No. 10,736,340 describes extrusion equipment which can be used in the processing and manufacture of pet foods.

U.S. published patent application US2023/0148630A1 refers to a lower density pet food product and its benefits. This publication describes the product in terms of its caloric density, ingredient ranges (fiber, protein, starch components), moisture content and the details of the formation of hollow core.

### SUMMARY OF THE DISCLOSURE

The present disclosure is directed to a process for producing a food product. The process comprises mixing a ground meat component with additional food components to form a first mixture. Adding CO₂ to the first mixture and mixing to form a second mixture. The mixing to produce the first mixture and the mixing to produce the second mixture occur at a temperature below zero.

In an aspect, the food product is a food product incorporating a set of ingredients processed into a freeze-dried end-product, the product incorporating a ground meat such as pork, chicken, beef or fish. In these formulations a ground meat starting component, combined with a solubilized or pre-gelatinized cereal grain and vegetables/fruits and other components, are used to deliver a product having optimized nutrition and digestibility. According to the disclosure the characteristics of a final food product are determined via a multi-step mixing, sizing and freeze-drying process that includes the exposure of at least a portion of the ground meat component to CO₂ gas. The combination of ingredients and processing conditions results in a highly nutritional end-product that is and convenient to use. In some implementations of the disclosure, the step of exposing ingredients to CO₂ is accomplished at specified temperatures and for a specified time so as to modify the physical product density of the final product. In some implementations, the ground meat component is raw ground meat.

Other aspects of the disclosure will be understood by reference to the detailed description set forth below.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1A is a flow chart illustrating an example implementation of a process for producing a food product.

FIG. 1B is a flow chart illustrating an example implementation of a process for producing a food product.

FIG. 1C is a flow chart illustrating an example implementation of a process for producing a pet food product.

FIG. 1D is a flow chart illustrating an example implementation of a process for producing a food product.

FIG. 1E is a flow chart illustrating an example implementation of a process for producing a food product.

FIG. 2A is a high-level sequence diagram illustrating one example implementation of a process for producing a food product.

FIG. 2B is a high-level sequence diagram illustrating one example implementation of a process for producing a food product.

FIGS. 3A and 3B are a high-level block diagram illustrating one example implementation of a system for producing a food product.

### DETAILED DESCRIPTION OF THE DISCLOSURE

Non-human animals should be provided with a diet that is balanced, species-appropriate, and tailored to their age, size, activity level, and health status. The food products described herein may be beneficial for those who work with non-human animals. Such uses may include captive breeding programs, zoos, wild animal rehabilitation clinics, stocking facilities, and pet stores. While the food products that are described herein may be familiar to owners of pets, particularly to terrestrial animals, the food products may be beneficial to other non-human animals. Canines and felines may be obvious choices for whom the food products may be used others may include birds, fish, cetaceans, rodents, mustelids, reptiles, or any other non-human animal.

Dogs are omnivores and thrive on a variety of foods, including high-quality animal proteins, fats, and digestible carbohydrates, along with essential vitamins and minerals. A complete and balanced dog diet should include lean meats like chicken, beef, lamb, or fish as a primary protein source to support muscle maintenance and overall health. Healthy fats, such as those from fish oil or chicken fat, provide energy and support skin and coat health. Carbohydrates like brown rice, sweet potatoes, or oats offer fiber and energy. Fruits and vegetables, such as carrots, spinach, and blueberries, can provide valuable antioxidants, fiber, and phytonutrients. It's also crucial that the diet includes adequate calcium and phosphorus for bone health, particularly in growing puppies.

Cats should eat a diet that is high in animal-based protein, moderate in fat, and very low in carbohydrates, reflecting their nature as obligate carnivores. Unlike dogs, cats cannot thrive on a diet high in plant material, as they require specific nutrients that are naturally found in meat, such as taurine, arachidonic acid, vitamin A, and vitamin B12. A nutritionally complete and balanced diet for cats should include high-quality meat or fish, such as chicken, turkey, beef, lamb, or salmon, which provide essential amino acids for muscle maintenance, energy, and immune function. Fat, from animal sources or fish oils, is an important source of energy and supports skin and coat health. While carbohydrates are not essential in a cat's diet, small amounts from sources like pumpkin or rice can aid digestion, though excessive carbs can contribute to obesity and diabetes.

The typical production of kibble, or dry pet food, begins with the selection and preparation of ingredients, which typically include animal proteins, grains or starches, fats, fiber, and a vitamin-mineral premix. These ingredients are ground into a fine meal to ensure even mixing and digestibility. Once ground, the components are blended into a dough-like mixture. This mixture is then cooked through a process called extrusion, where the dough is pushed through a machine called an extruder under high heat and pressure. The extrusion process cooks the ingredients rapidly, kills bacteria, and forms the mixture into uniformly shaped kibble pieces. When the hot mixture exits the extruder, it expands and is cut into the desired size and shape using rotating blades. After extrusion, the kibble is sent through a dryer to remove excess moisture, making it shelf-stable and reducing the risk of spoilage. Once dry, the kibble is sprayed with a coating of fats, oils, and flavor enhancers, which improve taste and help meet dietary fat requirements.

While the typical kibble may list the necessary nutrients for non-human animals, many non-human animal owners understand the nutritional advantages of incorporating meat protein into their non-human animal's diet. The present disclosure is directed to a food that incorporates such protein into a food product, but in a “kibble” style size and format that owners find familiar for dry foods (i.e. typical non-human animal foods that do not include raw meat protein). Non-human animal owners may thus more easily transition their non-human animal's diet from a more traditional dry kibble to a more nutritious product incorporating these preferred ingredients.

The food product of the disclosure is made from ground animal protein meat sources, such as beef, pork, chicken and/or fish. For other nutrients and fiber, fruits and vegetables may also be included. Sorghum may be used for its high micro-nutrient characteristics and soluble fiber content. In some implementations of the disclosure, cold pressed oils are utilized for their Omega-3 fatty acid content. Other ingredients such as kelp and alfalfa can be utilized for their micronutrient contributions. Probiotic microorganisms may be incorporated to provide a method of pathogen control.

Those skilled in the art will recognize that ingredient selection may vary depending on the animal targeted, including the age of the animal. Formulas that can be used as part of the disclosure include but are not limited to:

### Ingredient Example 1.1 Canine Beef:

Beef (with ground bone), Beef Liver, Sorghum, Organic Apple, Beef Tallow, Egg, Salmon Oil, Organic Sweet Potato, Organic Carrot, Beef Plasma, Organic Kale, Organic Spinach, Montmorillonite Clay, Miscanthus Grass, Organic Coconut, Cod Liver Oil, Dried Yeast, Vitamin E Supplement, Vegetable Oil, Organic Ground Alfalfa, Inulin, Dried Organic Kelp, Liquid Lactobacillus acidophilus fermentation product, Liquid Lactobacillus casei fermentation product, Liquid Lactobacillus reuteri fermentation product, Liquid Bifidobacterium animalis fermentation product, Mixed Tocopherols (Preservative), Taurine, Green Tea Extract, Rosemary Extract.

### Ingredient Example 1.2 Canine Beef:

Beef (with ground bone), Beef Livers, Sorghum, Organic Apple, Beef Tallow, Egg, Salmon Oil, Organic Sweet Potato, Organic Carrot, Beef Plasma, Organic Kale, Organic Spinach, Montmorillonite Clay, Miscanthus Grass, Organic Coconut, Dried Yeast, Cod Liver Oil, Vitamin E Supplement, Vegetable Oil, Organic Ground Alfalfa, Inulin, Dried Organic Kelp, Mixed Tocopherols (Preservative), Taurine, Green Tea Extract, Rosemary Extract

### Ingredient Example 2.1 Canine Chicken:

Chicken (with ground bone), Sorghum, Chicken Liver, Organic Carrot, Egg, Organic Sweet Potato, Salmon Oil, Organic Kale, Chicken Fat, Organic Apple, Dried Yeast, Montmorillonite Clay, Miscanthus Grass, Organic Coconut, Cod Liver Oil, Vitamin E Supplement, Vegetable Oil, Organic Ground Alfalfa, Inulin, Dried Organic Kelp, Liquid Lactobacillus acidophilus fermentation product, Liquid Lactobacillus casei fermentation product, Liquid Lactobacillus reuteri fermentation product, Liquid Bifidobacterium animalis fermentation product, Mixed Tocopherols (Preservative), Taurine, Green Tea Extract, Rosemary Extract.

### Ingredient Example 2.2 Canine Chicken:

Chicken (with ground bone), Sorghum, Chicken Livers, Organic Carrot, Egg, Organic Sweet Potato, Salmon Oil, Chicken Fat, Chicken Plasma, Organic Kale, Organic Apple, Dried Yeast, Montmorillonite Clay, Miscanthus Grass, Organic Coconut, Cod Liver Oil, Vitamin E Supplement, Vegetable Oil, Organic Ground Alfalfa, Inulin, Dried Organic Kelp, Mixed Tocopherols (Preservative), Taurine, Green Tea Extract, Rosemary Extract.

### Ingredient Example 3.1 Canine Chicken (Small Breed):

Chicken (with ground bone), Sorghum, Chicken Liver, Organic Carrot, Egg, Organic Sweet Potato, Salmon Oil, Organic Kale, Chicken Fat, Organic Apple, Dried Yeast, Montmorillonite Clay, Miscanthus Grass, Organic Coconut, Cod Liver Oil, Vitamin E Supplement, Vegetable Oil, Organic Ground Alfalfa, Inulin, Dried Organic Kelp, Liquid Lactobacillus acidophilus fermentation product, Liquid Lactobacillus casei fermentation product, Liquid Lactobacillus reuteri fermentation product, Liquid Bifidobacterium animalis fermentation product, Mixed Tocopherols (Preservative), Taurine, Green Tea Extract, Rosemary Extract.

### Ingredient Example 3.2 Canine Chicken (Small Breed):

Chicken (with ground bone), Sorghum, Chicken Livers, Organic Carrot, Egg, Organic Sweet Potato, Salmon Oil, Chicken Fat, Chicken Plasma, Organic Kale, Organic Apple, Dried Yeast, Montmorillonite Clay, Miscanthus Grass, Organic Coconut, Cod Liver Oil, Vitamin E Supplement, Vegetable Oil, Organic Ground Alfalfa, Inulin, Dried Organic Kelp, Mixed Tocopherols (Preservative), Taurine, Green Tea Extract, Rosemary Extract.

### Ingredient Example 4.1 Canine Fish Pork:

Pacific Whiting, Pork (with ground bone), Sorghum, Pork Liver, Salmon Oil, Pork Lard, Egg, Organic Sweet Potato, Organic Apple, Organic Carrot, Pork Plasma, Organic Kale, Organic Spinach, Dried Yeast, Montmorillonite Clay, Miscanthus Grass, Organic Coconut, Vitamin E Supplement, Vegetable Oil, Cod Liver Oil, Organic Ground Alfalfa, Inulin, Dried Organic Kelp, Liquid Lactobacillus acidophilus fermentation product, Liquid Lactobacillus casei fermentation product, Liquid Lactobacillus reuteri fermentation product, Liquid Bifidobacterium animalis fermentation product, Mixed Tocopherols (Preservative), Taurine, Green Tea Extract, Rosemary Extract.

### Ingredient Example 4.2 Canine Fish Pork:

Pacific Whiting, Pork (with ground bone), Sorghum, Pork Livers, Salmon Oil, Pork Lard, Egg, Organic Sweet Potato, Organic Apple, Organic Carrot, Pork Plasma, Organic Kale, Organic Spinach, Dried Yeast, Montmorillonite Clay, Miscanthus Grass, Organic Coconut, Vitamin E Supplement, Vegetable Oil, Cod Liver Oil, Organic Ground Alfalfa, Inulin, Dried Organic Kelp, Mixed Tocopherols (Preservative), Taurine, Green Tea Extract, Rosemary Extract.

### Ingredient Example 5.1 (Puppy):

Chicken (with ground bone), Chicken Liver, Sorghum, Pork (with ground bone), Pork Plasma, Egg, Salmon Oil, Organic Carrot, Organic Kale, Organic Apple, Organic Sweet Potato, Chicken Fat, Dried Yeast, Sea Salt, Montmorillonite Clay, Miscanthus Grass, Organic Coconut, Vitamin E Supplement, Vegetable Oil, Cod Liver Oil, Organic Ground Alfalfa, Inulin, Dried Organic Kelp, Liquid Lactobacillus acidophilus fermentation product, Liquid Lactobacillus casei fermentation product, Liquid Lactobacillus reuteri fermentation product, Liquid Bifidobacterium animalis fermentation product, Mixed Tocopherols (Preservative), Taurine, Green Tea Extract, Rosemary Extract.

### Ingredient Example 5.2 Puppy:

Chicken (with ground bone), Chicken Livers, Sorghum, Pork (with ground bone), Pork Plasma, Egg, Salmon Oil, Organic Carrot, Organic Kale, Organic Sweet Potato, Organic Apple, Chicken Fat, Dried Yeast, Salt, Montmorillonite Clay, Miscanthus Grass, Organic Coconut, Vitamin E Supplement, Vegetable Oil, Cod Liver Oil, Organic Ground Alfalfa, Inulin, Dried Organic Kelp, Mixed Tocopherols (Preservative), Taurine, Green Tea Extract, Rosemary Extract.

### Ingredient Example 6.1 Feline Beef:

Beef (with ground bone), Beef Livers, Sorghum, Beef Plasma, Egg, Salmon Oil, Organic Apple, Organic Sweet Potato, Beef Tallow, Organic Carrot, Organic Kale, Organic Spinach, Dried Yeast, Salt, Montmorillonite Clay, Organic Coconut, Miscanthus Grass, Vitamin E Supplement, Cod Liver Oil, Vegetable Oil, Taurine, Organic Ground Alfalfa, Inulin, Dried Organic Kelp, Mixed Tocopherols (Preservative), Green Tea Extract, Rosemary Extract.

### Ingredient Example 7.1 Feline Chicken:

Chicken (with ground bone), Chicken Livers, Sorghum, Egg, Salmon Oil, Chicken Plasma, Organic Carrot, Organic Sweet Potato, Chicken Fat, Organic Kale, Organic Apple, Dried Yeast, Salt, Montmorillonite Clay, Organic Coconut, Miscanthus Grass, Vitamin E Supplement, Cod Liver Oil, Vegetable Oil, Taurine, Organic Ground Alfalfa, Inulin, Dried Organic Kelp, Mixed Tocopherols (Preservative), Green Tea Extract, Rosemary Extract.

### Ingredient Example 8.1 Feline Chicken Fish:

Chicken (with ground bone), Pacific Whiting, Chicken Livers, Sorghum, Egg, Salmon Oil, Chicken Plasma, Organic Carrot, Organic Sweet Potato, Chicken Fat, Organic Kale, Dried Yeast, Salt, Montmorillonite Clay, Organic Coconut, Miscanthus Grass, Vitamin E Supplement, Cod Liver Oil, Vegetable Oil, Taurine, Organic Ground Alfalfa, Inulin, Dried Organic Kelp, Mixed Tocopherols (Preservative), Green Tea Extract, Rosemary Extract.

### Process/Method

The following processes are described with references to meat. The meat may be of any source such as beef, pork, fish, chicken, turkey, or any other meat. Additionally, the meat may be raw, cooked, or partially cooked.

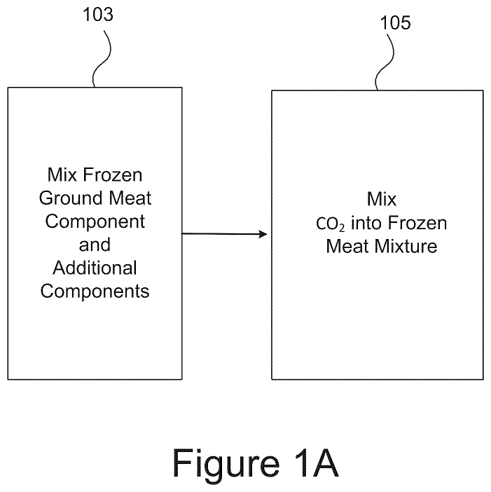

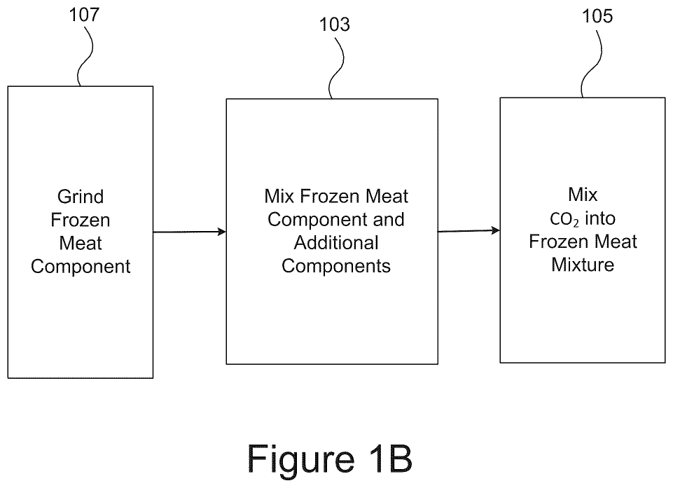

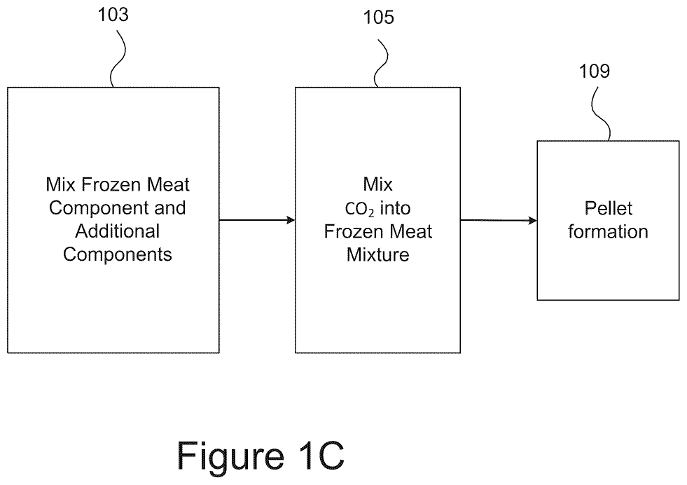

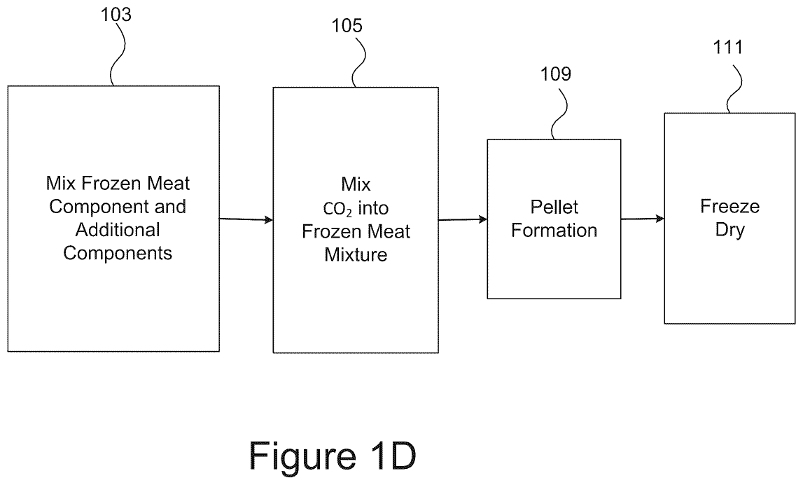

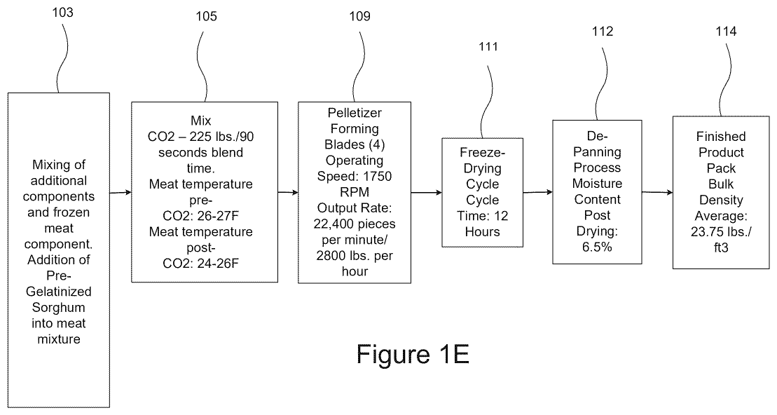

In the preparation of meat kibble-like food products it is important to prepare the food products in such a way as to prevent bacterial contamination; this is particularly important in implementations utilizing raw meat. To that end, the grinding and mixing steps of the process may proceed under cold temperatures. In implementations, the density of the product is achieved through the process by which the ingredients are combined, permitting the incorporation of animal meat sources (fish, pork, beef and chicken) into a freeze-dried kibble-like end product. A specific example of a process is set forth in FIG. 1.

FIG. 1A is a block diagram of a process of preparing ground meat into a food product. The process includes mixing 103 a frozen ground meat component with additional components. In implementations, the ground meat product is beef, chicken, pork, fish, or combinations thereof. In some implementations, the ground meat product includes bones. In some implementations, the ground meat product includes organs such as liver, heart, or the like. In implementations, the frozen ground meat comprises raw meat. In implementations, the additional components may include one or more of produce, oils, fats, solubilized or pre-gelatinized cereal grain, and nutritional supplements. The additional components may be added as a single addition, or the additional components may be added individually. The additional components may be added over a period of time. Each component may be added over a period of time, or the additional components may be grouped together and added over a period of time. The frozen ground meat component and the additional components may be mixed until the mixture reaches a predominantly consistent texture. The mixing 103 of the ground meat component and the other components produces a first mixture. During this mixing process the temperature of the first mixture may rise. This is likely due to friction during the mixing process. CO₂ mixing 105 comprises mixing the first mixture with the CO₂. A second mixture is formed once the CO₂ is mixed with the first mixture. The addition of CO₂ may lower the temperature of the second mixture as compared to the first mixture. In some implementations, the addition and mixing of the CO₂ may lower the temperature of the second mixture by from about 1° F. to about 4° F. as compared to the temperature of the first mixture. In some implementations, the CO₂ is a gas. In implementations, the CO₂ is maintained at a temperature below 0° F. In some implementations, the CO₂ may be liquid.

In some implementations, the mass of the batch is from about 800 lbs. to about 1,800 lbs. In some implementations, the mass of the batch is about 1,200 lbs. In implementations, the specific components of the food mixture determine the mass of the batch for example, the canine beef formulation may have a batch mass of about 1197.4 lbs. The canine chicken formulation may have a batch mass of about 1183.3 lbs. The canine fish/pork formulation may have a batch mass of about 1177.1 lbs. The canine puppy formulation may have a batch mass of about 1188.8 lbs. The feline chicken formulation may have a batch mass of about 1216.9 lbs. The feline chicken/fish formulation may have a batch mass of about 1199.9 lbs. The feline beef formulation may have a batch mass of about 1208.9 lbs.

The amount of CO₂ may be the same irrespective of the mass of each batch. The ratio of CO₂ to food mixture may therefore change relative to the batch size. In some implementations the ratio of CO₂ to food mixture prior to CO₂ incorporation may be from about 12% to about 28%. In some implementations, the ratio of CO₂ to food mixture prior to CO₂ incorporation may be about 19%. In implementations, the ratio of CO₂ to food mixture prior to CO₂ incorporation may be about 12, 13, 14, 15, 16, 17, 18, 19, 20, 21, 22, 23, 24, 25, 26, 27, or 28%.

In implementations, the mixing time to produce the first mixture is from about 16:00 minutes to about 25:30 minutes. In some implementations, the mixing time to produce the first mixture is from about 18:00 minutes to about 23:30 minutes. In implementations, the mixing time to produce the first mixture is about 16:00, 16:30, 17:00, 17:30, 18:00, 18:30, 19:00, 19:30, 20:00, 20:30, 21:00, 21:30, 22:00, 22:30, 23:00, 23:30, 24:00, 24:30, 25:00, or 25:30 minutes.

In implementations, the mixing time to produce the second mixture is from about 30 seconds to about 150 seconds. In implementations, the mixing time to produce the second mixture is about 30, 60, 90, 120, or 150 seconds. In implementations, the mixing time to produce the second mixture is about 90 seconds.

In implementations, the total mixing time, or the mixing time to produce the first mixture combined with the mixing time to produce the second mixture is from about 16:00, 16:30, 17:00, 17:30, 18:00, 18:30, 19:00, 19:30, 20:00, 20:30, 21:00, 21:30, 22:00, 22:30, 23:00, 23:30, 24:00, 24:30, 25:00, 25:30, 26:00, 26:30, 27:00, 27:30, or 28:00 minutes.

While not being bound to any particular theory, the addition of CO₂ may perform a number of roles. The CO₂ may rapidly cool the meat mixture, as may be seen in a temperature reduction of the meat mixture. The CO₂ may also assist by creating a protective cold atmosphere around the raw meat mixture. CO₂ does not kill pathogens, but it does create an unfavorable environment for may microbes, thus slowing the growth of bacteria that may cause spoilage. CO₂ may displace oxygen around the meat mixture, removing oxygen may slow the oxidation of fats and pigments in the raw meat mixture. Slowing the oxidation delays rancidity and preserves the color and flavor of the meat mixture. This may also help maintain the texture, juiciness, and appearance of the raw meat mixture during storage and transport. The CO₂ may also assist in tenderizing the meat within the meat mixture as CO₂ may physically disrupt the muscle fibers. The addition of CO₂ may be beneficial to use with implementations utilizing raw meat. The benefits described above are useful with implementation that do not involve cooking or other means of treating meat.

Another way in which the CO₂ may affect the final product is that the addition of CO₂ in the manner described may produce a bulk density reduction while maintaining all nutritional parameters. Further, during the CO₂ addition and mixing process, the glass phase transition temperature of the meat matrix may be modified/moderated with CO₂ (approximately-69° F.) to partially catalyze a glass phase transition thus lowering the relative bulk density of the matrix. A reduction in moisture due to the incorporation of CO₂ into the meat matrix may facilitate the bulk density reduction. As the moisture in the meat matrix becomes colder due to the introduction of CO₂, the water molecules may freeze, wicking moisture from the blended matrix and reducing the bulk density of the overall blended material.

This lowering of the bulk density may be preserved via cold forming and freeze-drying technology allowing for a product with a 10-20 percent reduction in bulk density compared to a control which was not processed with the addition and mixing of CO₂.

Methods of the disclosure may reduce or inhibit acrylamide in the dehydration phase, as studies have shown that use of CO₂ may inhibit this byproduct of dehydration/heat.

FIG. 1B is a block diagram of a process of preparing meat into a food end product. Implementations, include grinding 107 the meat before mixing 105. In some implementations, the meat may be cuts of meat. In some implementations, the meat may be cooked or partially cooked. In some implementations, the meat may be frozen. In some implementations, the frozen meat component may be cuts of raw meat. In these implementations, the frozen raw meat component may be ground. The frozen meat product may be ground prior to the addition of the additional components. In some implementations, once the frozen meat product has been ground, the frozen meat product may be moved to a mixing or blending device. In some implementations, the mixing of the frozen meat product occurs in the same device as the grinding, and the frozen meat product remains in the same device while the additional components are added to the frozen meat component for mixing. Following the grinding 107 of the frozen meat component, the process may proceed as in FIG. 1. The frozen meat component may be mixed 103 with additional components. Once the frozen meat component and the additional components have been mixed, CO₂ mixing 105 may incorporate CO₂.

FIG. 1C is a block diagram of the process of preparing meat into a food end product. The mixing 103, and CO₂ mixing 105 steps may proceed as in FIG. 1A or 1B. Following the CO₂ mixing 105, the frozen meat mixture may be formed 109 into pellets. The forming 109 of frozen meat mixture pellets may begin with moving the frozen meat mixture to a pelletizer. In some implementations, a vacuum pump moves the frozen meat mixture to the pelletizer. In implementations, the pelletizer includes extruding the frozen meat mixture through a die and cutting the extruded frozen meat mixture at intervals to produce pellets. In implementations, the pellets are a predetermined size to produce a product that is kibble-like and familiar in form to non-human animal owners and to non-human animals. In some implementations, dies of different sizes and shapes may be used. Additional sizes and shapes of dies may enable the production of non-human animal treats or other non-human animal food products. In some implementations, ground meat may be used for producing the food product. In such implementations, the cooked meat may be substituted for raw meat in the formation mixing step and throughout the process.

FIG. 1D is a block diagram of a process of preparing meat into a food end product. The mixing 103, CO₂ mixing 105, and forming 109 of pellet steps may proceed as in FIG. 1A, 1B, or 1C. Following pelletization, the frozen meat mixture pellets are subjected to freeze drying 111. Freeze drying 111 may remove significant amounts of moisture from the frozen meat mixture pellets. In implementations, the frozen meat mixture pellets may retain from about 1.0% to about 8.0% moisture. In implementations, the frozen meat mixture pellets may retain about 6.5% moisture. In implementations, the frozen meat mixture pellets may retain about 1.0, 1.5, 2.0, 2.5, 3.0, 3.5, 4.0, 4.5, 5.0, 5.5, 6.0, 6.5, 7.0, 7.5, 8.0% The reduction of moisture through freeze drying also reduces the density of the frozen meat mixture pellets. The reduction in density may be from 10 to 20% as compared to a product which has not been prepared by CO₂ mixing 105 and freeze drying 111. Freeze drying may be beneficial to the production of a meat kibble-like food product for several reasons, freeze drying helps retain nutrients such as natural proteins, enzymes, and amino acids. The freeze-dried kibble-like food product may be shelf stable; this makes it more like traditional kibble and may be more familiar for many people as well as more familiar for non-human animals to eat. Freeze dried product may also taste like real meat, which may be more palatable for some non-human animals. Freeze-dried kibble like non-human animal food products may offer less bacterial risk as compared to other meat options.

FIG. 1E is a block diagram of a process of preparing meat into a food end product. The mixing 103, CO₂ mixing 105, and forming 109 of pellets may proceed as in FIG. 1A, 1B, 1C, or 1D with the addition of specific amounts of many of the components. The frozen meat component and the additional components are mixed 103 together. The additional components may include the addition of pre-gelatinized sorghum. Then in the CO₂ mixing 105, 225 lbs. of CO₂ are added and blended with the frozen meat mixture for 90 seconds. Prior to the addition and mixing of CO₂, the frozen meat mixture temperature may rise to about 26° F. to about 27° F. After the CO₂ addition and 90 second blending time the frozen meat mixture temperature may be reduced to about 24 to about 26° F. In the forming 109 of the pellets four blades operate at a speed of 1,750 RPM. The pelletizer had an output rate of 22,400 pieces per minute or 2,800 lbs. per hour. The freeze-drying step 109 includes freeze drying the frozen meat pellets for cycles of 12 hours per cycle. Following freeze drying 111, the frozen meat mixture pellets are taken off the pans of the freeze dryer and have a moisture content of about 6.5%. The packaging 114 the finished product, a meat kibble-like product that has a bulk pack density of 23.75 lbs. per ft³.

In implementations, the bulk pack density is from 20.00 lbs. per ft³ to about 28.00 lbs. per ft³. In implementations, the bulk pack density is 20.00, 20.25, 20.50, 20.75, 21.00, 21.25, 21.50, 21.75, 22.00, 22.25, 22.50, 22.75, 23.00, 23.25, 23.50, 23.75, 24.00, 24.25, 24.50, 24.75, 25.00, 25.25, 25.50, 25.75, 26.00, 26.25, 26.50, 26.75, 27.00, 27.25, 27.50, 27.75, or 28.00 lbs. per ft³.

The food product may be generally formulated for a family of non-human animals, such as canines or felines. The food product may be formulated for different breeds within the family. The food product may also be formulated for specific ages or growth periods of an animal's lifetime. In such implementations, the food product may be formulated for puppies or kittens. Such family specific and age specific formulations are not limited to canines and felines. Other non-human animals may also receive formulations specific to their nutritional and growth needs.

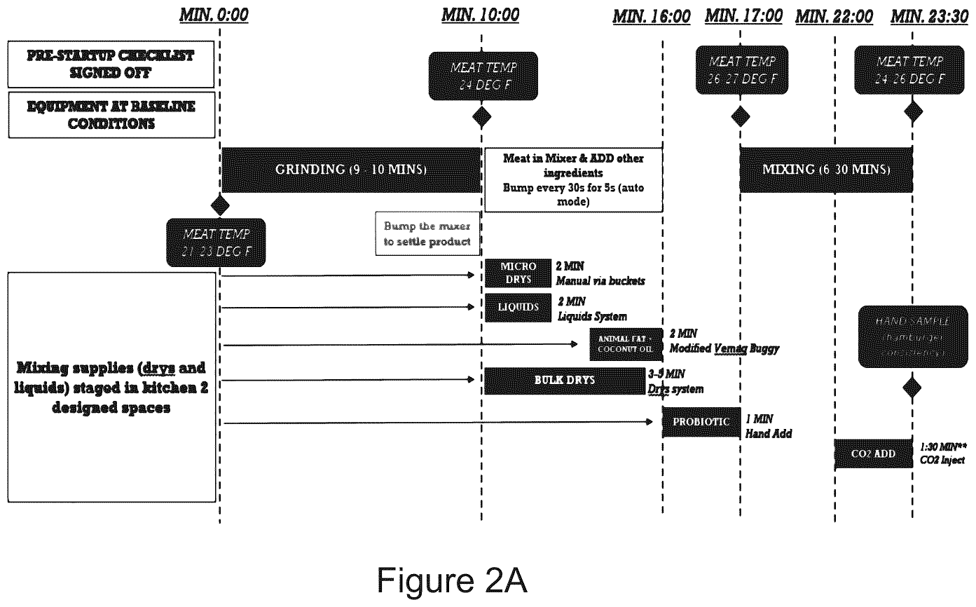

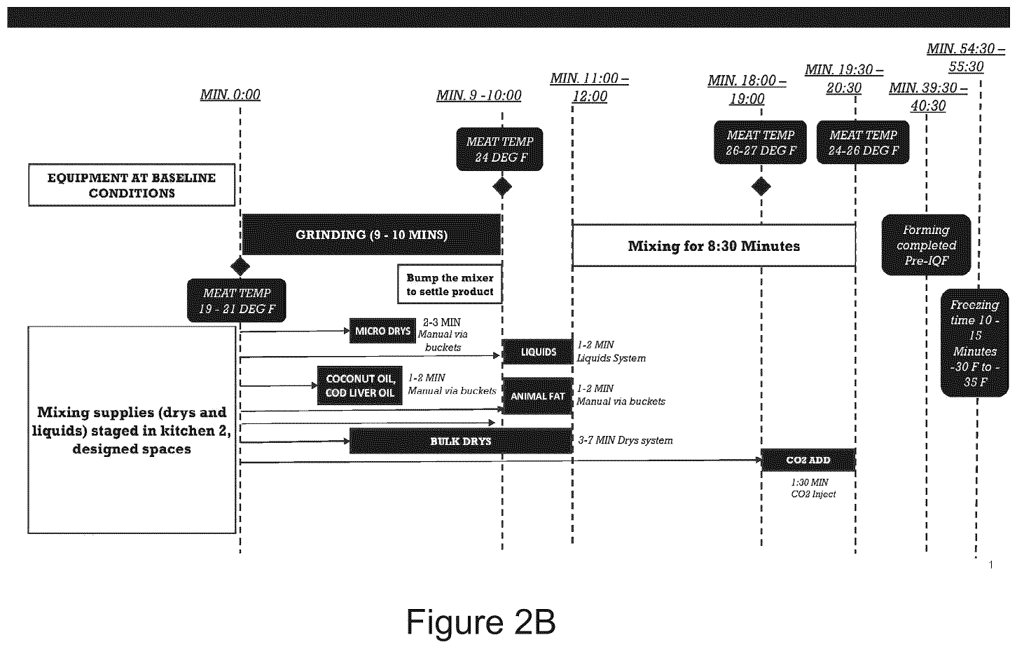

As can be seen, FIG. 2A sets forth a timeline across a process of the disclosure leading to CO₂ addition and mixing as it appears at the minute 22 point on that chart.

FIG. 2A is a depiction of one implementation of a process for producing kibble-like food product. A frozen meat component may be placed into the grinding system at 21-23° F., ground to ⅛″, and then deposited into the blending system. The frozen meat component may be ground for approximately 10 minutes. In some implementations, the blending may be accomplished in the grinding system. In some implementations, the blending system may be a separate device in which the ingredients are mixed. In some implementations, during this process, the blending system may be activated intermittently, in some implementations, every 30 seconds, to properly incorporate the meat protein materials. After the approximately 10-minute grind time, the meat component may have increased in temperature to 24° F.

As further shown in FIG. 2A, once the meat protein materials have been deposited into the blender or mixer, produce items, omega3 oils, and all supplements are added to the blender and mixed for approximately 6 minutes. The produce items including micro drys, liquids, fats, oils, and bulk drys, may be added at different times, and incorporated over different periods of time. The micro drys and liquids may be added at the 10-minute mark and added over a period of two minutes. The bulk drys may be incorporated at the 10-minute mark and incorporated over a 3-5 minute period. The fats and oils may be added at the 14-minute mark and incorporated over a 2-minute period. By varying the time at which ingredients are added and the time over which the ingredients are incorporated, the ingredients may be better incorporated, and the mixture may have a more uniform consistency. At minute sixteen, probiotics may be added to the blender, the duration of this process may be approximately one minute. At this point in the process, the meat mixture may be approximately 26-27° F. and blending continues for an additional 5 minutes.

At the twenty-two-minute mark, in an implementation of the disclosure, 225 lbs. of CO₂ may be added to the blender or mixer for 90 seconds. This may reduce the meat mixture temperature to 24-26° F. At this stage, the meat mixture may be the consistency of ground hamburger with a lower density due to the incorporation of CO₂. Input pressure of CO₂ may be maintained at approximately 100 PSI during the mixing process. Following the completion of mixing, the mixture may be formed into pellets. The pellets may then be frozen.

FIG. 2B is a depiction of one implementation of a process for producing a kibble-like food product. A frozen meat component may be placed into the grinding system at 19-21° F., ground to ⅛″, and then deposited into a blending system. The frozen meat may be ground for about 9-10 minutes. In some implementations, the blending may be accomplished in the grinding system. In some implementations, the blending system may be a separate device in which the ingredients are mixed. In some implementations, during this process, the blending system may be activated intermittently, in some implementations, every 30 seconds, to properly incorporate the frozen meat component. After approximately 10-minute grind time, the frozen meat component may have increased in temperature to 24° F.

As further shown in FIG. 2B, during the grinding process, produce items, oils, and all supplements are added to the grinding system and mixed into the meat proteins. The produce items including micro drys, liquids, fats, oils, and bulk drys, may be added at different times, and incorporated over different periods of time. The oils may be added after the meat has been ground for about 2-4 minutes. The oils may be incorporated over about 1-2 minutes. The micro drys may be added after about 4-5 minutes added over a period of about 2-3 minutes. The bulk drys may be incorporated after about 4-5 minutes and incorporated over a 3-7 minute period. The remaining liquids and the animal fats may be added after about 9-10 minutes and incorporated over about a 1-2 minute period. By varying the time at which ingredients are added and the time over which the ingredients are incorporated, the ingredients may be better incorporated, and the mixture may have a more uniform consistency. The meat temperature may increase during the 9-10 minute grinding time to a temperature of about 24° F. After the liquids and animal fats have been incorporated, at about 11-12 minutes, the mixture continues to mix for about 8.5 minutes. For about seven of those minutes the mixture may be mixed without any additions. After about 7 minutes, the temperature of the meat mixture may have increased to about 26-27° F. Carbon dioxide (CO₂) may be then added into the mixture, or the frozen meat mixture may be exposed to CO₂. In some implementations 225 lbs. of CO₂ may be added and mixed for 90 seconds (minimum per 2000 lb. batch). This may reduce the meat mixture temperature to 24-26° F. At this stage, the frozen meat mixture may be the consistency of ground hamburger with a lower density due to the incorporation of CO₂. Input pressure of CO₂ may be maintained at approximately 100 PSI during the mixing process. The addition of CO₂ may help protect the food product. CO₂ may slow the growth of bacteria that cause spoilage, such as aerobic bacteria such as Pseudomonas. The CO₂ does not kill the pathogens outright but creates an unfavorable environment for microbes. CO₂ may also displace oxygen, which may slow the oxidation of fats and pigments. By slowing oxidation, rancidity may be delayed, and color and flavor are preserved.

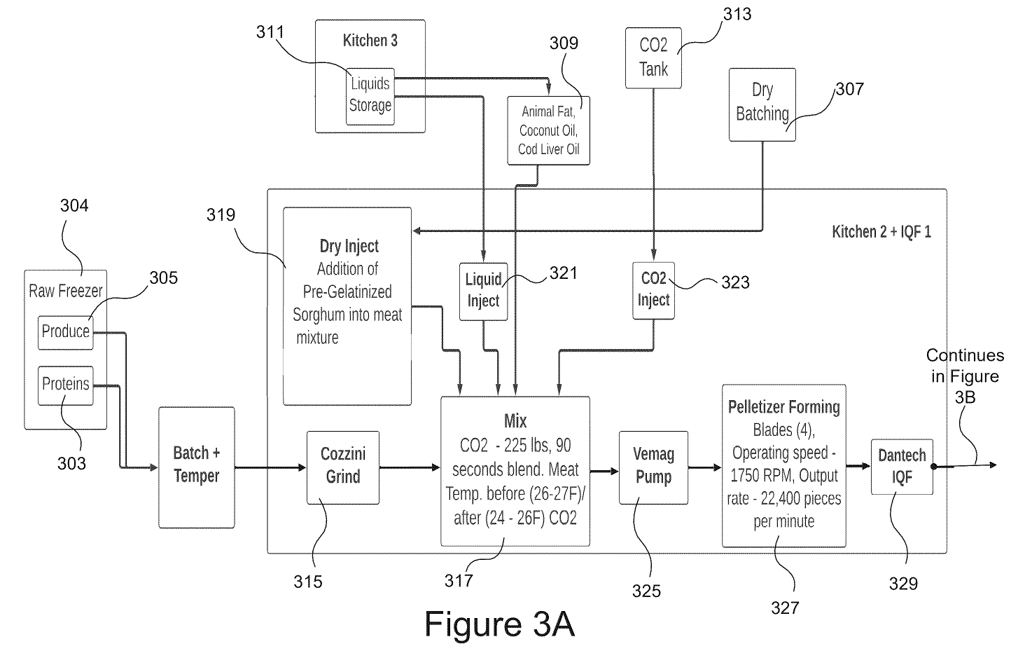

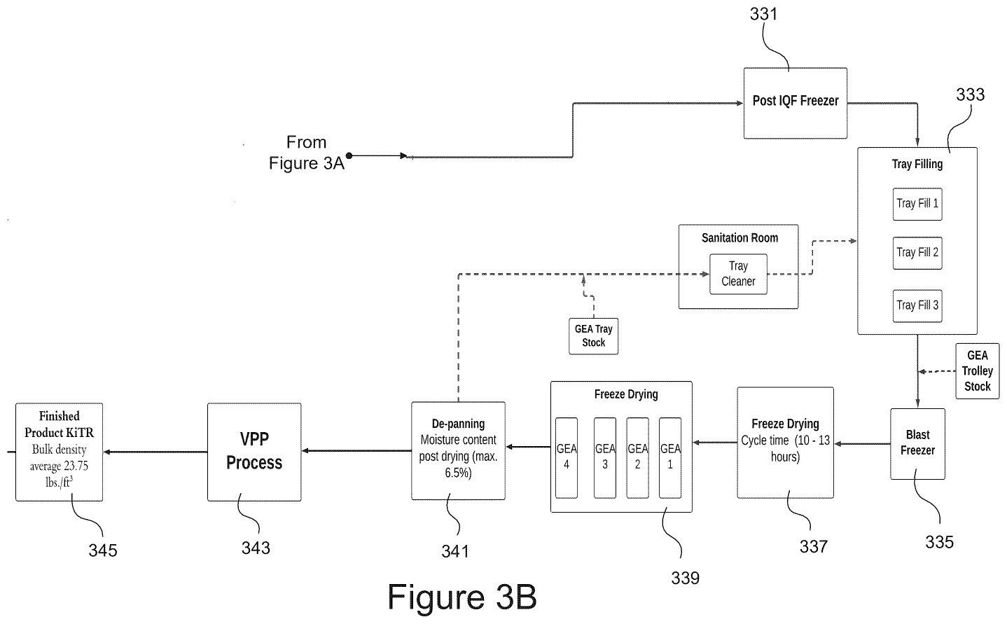

A full process of producing raw meat pet food products is depicted in FIGS. 3A and 3B. Frozen raw meat 303 is stored in a freezer 304 on site. In some implementations, the frozen raw meat 303 is cuts of meat, In some implementations, the frozen raw 303 meat arrives at the facility as ground meat. Produce 305 is also stored in the freezer 304. The ingredients may include egg, plasma, organs, yeast, sweet potatoes, apples carrots, kale, coconut, alfalfa, tallow, and miscanthus grass. Dry ingredients such as sorghum, dried kelp, and montmorillonite clay are stored and batched together 307. Liquids 311 such as rosemary extract, green tea extract, oils, and fats are stored such that they remain as liquids 311 until they are added to the mixture. This is to assist in adding the liquids 311 to the mixture. Liquids 311 may be moved through conduits from the storage to the mixing device. The raw meat 303 is transferred into a grinder 315. In some implementations the grinder is a Cozzini grinder 315. Frozen raw meat 303 may be placed into the grinder 315. The frozen raw meat 303 may be ground to ⅛″. In some implementations, the mixing occurs in the same device as the grinding. In these implementations, the additional ingredients including produce are then deposited into the mixing system to be mixer. In some implementations, the mixing of the ingredients occurs in a separate device 317, in these implementations, the ground raw meat 303 is transferred to the mixing or blending device 317. During the mixing process the additional ingredients are added. The additional ingredients may be added all at once or slowly over an extended period of time. The dry ingredients 307 prepared in a batch, may be added through a dry injection 319. The main ingredient of the dry addition is pre-gelatinized sorghum. It may be added to the raw meat over a period of from about 2 minutes to about 7 minutes. The oils 309 may be added over a period of between 1 and 3 minutes. The liquids 311 may be added through an injection mechanism 321 over a period of between 1 and 2 minutes. The ingredients are mixed in the mixer 317 to fully incorporate all of the ingredients. Once all the ingredients are incorporated, CO₂ is added through an injection device 323 to the mixture. The CO₂ is stored in CO₂ tank 313 and injected through an injection device 323 into the mixture. The CO₂ is typically a gas and is mixed or blended, in the mixer 317, with the mixture for between about 1 minute and two minutes. In some implementations, the mixing of the CO₂, in the mixer 317, into the mixture occurs for about 90 seconds. The addition of the CO₂ may decrease the temperature of the mixture. In some implementations the temperature may be decreased by between about 2° F. and 4° F. In some implementations, the temperature may be decreased from between about 26° F. to about 27° F. to between about 24° F. to 26° F.

The addition of the CO₂ may perform a number of roles. The CO₂ may rapidly cool the frozen raw meat mixture, as can be seen in the temperature reduction of the frozen raw meat mixture. The CO₂ may also assist by creating a protective cold atmosphere around the frozen raw meat mixture. CO₂ may not kill pathogens but may create an unfavorable environment for may microbes, thus it may slow the growth of bacteria that may cause spoilage. CO₂ may displace oxygen around the frozen raw meat mixture, and removing oxygen may slow the oxidation of fats and pigments in the frozen raw meat mixture. Slowing the oxidation may delay rancidity and may preserve the color and flavor of the frozen raw meat mixture. This may also help maintain the texture, juiciness, and appearance of the frozen raw meat mixture during storage and transport. The CO₂ may also assist in tenderizing the meat within the frozen raw meat mixture as CO₂ may physically disrupt the muscle fibers.

At this stage, the frozen raw meat mixture may be the consistency of ground hamburger with a lower density due to the incorporation by mixing of CO₂. Input pressure of CO₂ may be maintained at approximately 100 PSI during the grinding process.

The frozen raw meat mixture may be discharged from the mixer 317 onto a transfer conveyor and deposited into a vacuum pump 325. The vacuum pump 325 may move the frozen raw meat mixture into the head of a depositing device at 3 Bar.

The frozen raw meat mixture may be formed into pellets by a pelletizer 327 which divides the frozen raw meat mixture into portions of the frozen raw meat mixture utilizing 4 blades operating at 1750 RPM producing 22,400 pieces per minute. The deposited pieces (approximately 28° F.) may be carried away by a transfer conveyor, enter a mechanical (post Individual Quick Freeze (IQF) 329 freezer operating at −26° F. and are frozen in 11 minutes (dwell time) to a core temperature of approximately 12° F. Frozen pieces are then placed on aluminum trays 333 with a total weight of 13.75. The trays are moved to a blast freezer 335.

A total of 300 trays are placed into the GEA freeze dryer 337 and processed for between about 10 hours and about 13 hours until the pelletized frozen raw meat mixture reaches a maximum moisture level of approximately 6.5% and pelletized frozen raw meat mixture is now a freeze-dried food product. The freeze-dried food product is then collected in a collection bin 343. The product is then packaged 345 and tested to confirm negative for pathogenic bacteria.

In this example, the key finished product benchmarks are:
Average Nitrogen-Corrected True Metabolizable Energy: 5,355 kcal/kg,
Average Total Tract Dry Matter Digestibility: 88.24%, and
Apparent Total Tract Energy Digestibility: 91.96%.

A food product and a system and methods for manufacturing a food product has been described. In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding. It should be understood that the techniques described herein may be automated using any relevant or useful software and/or hardware.

Reference in the specification to “one implementation” or “an implementation” means that a particular feature, structure, or characteristic described in connection with the implementation is included in at least one implementation. The appearances of the phrase “in one implementation” in various places in the specification are not necessarily all referring to the same implementation.

Accordingly, the disclosure is intended to be illustrative, but not limiting, of the scope of the subject matter set forth in the following claims.

What is claimed is:

1. A process for producing a food product, the process comprising:
mixing a ground meat component with additional food components to form a first mixture; and
adding CO₂ to the first mixture and mixing the CO₂ with the first mixture to form a second mixture;
wherein the mixing to produce the first mixture and the mixing to produce the second mixture occur at a temperature below 0° F.

2. The process according to claim 1, wherein the mixing to produce the first mixture and/or the mixing to produce the second mixture takes place at between about 18° F. and about 28° F.

3. The process according to claim 1, wherein the mixing of the CO₂ and the first mixture lowers a temperature of the second mixture as compared to the first mixture by between about 1° F. and about 4° F.

4. The process according to claim 3, wherein the CO₂ is a gas.

5. The process according to claim 1, wherein the ground meat component comprises raw meat.

6. The process of claim 1, wherein the mixing of the CO₂ to the first mixture reduces the density of the second mixture by less than 10% as compared to the first mixture.

7. The process according to claim 1, further comprising pelletizing the second mixture.

8. The process according to claim 7, further comprising flash freezing the pelletized second mixture.

9. The process according to claim 7, further comprising freeze drying the pelletized second mixture.

10. The process according to claim 9, wherein the freeze dried pelletized second mixture has a reduced density as compared to an otherwise identical food product produced by a process lacking the mixture of CO₂ with the first mixture and the freeze drying.

11. The process according to claim 10, wherein the density of the food product is reduced by between about 8% and about 25%.

12. The process according to claim 1, wherein the food product is formulated for non-human animals.

13. The process according to claim 12, wherein the food product is formulated for canines.

14. The process according to claim 13, wherein food product is formulated for canine puppies.

15. The process according to claim 1, wherein pet food product is formulated for felines.

16. A food product produced by the process of claim 1.

17. The product of claim 16, wherein the ground meat component comprises raw meat.

18. The product of claim 17, wherein the process of claim 1 further comprises freeze drying the food product.

19. The product of claim 18, wherein the density of the food product is reduced by between about 8% and about 25% as compared to a food product made by a process not including CO₂ mixing and freeze drying.

20. The product of claim 16, wherein the product is formulated for non-human animals.
